(19) United States
(12) Patent Application Publication
(10) Pub. No.: US 2025/0308534 A1
(43) Pub. Date: Oct. 2, 2025

(54) SEGMENTING TRANSCRIPTS INTO NATURALISTIC CONVERSATIONAL TURNS

(71) Applicant: BetterUp, Inc., Austin, TX (US)

(72) Inventors: Andrew Reece, Phippsburg, ME (US); Gus Cooney, Philadelphia, PA (US)

(73) Assignee: BetterUp, Inc., Austin, TX (US)

(21) Appl. No.: 19/090,208

(22) Filed: Mar. 25, 2025

Related U.S. Application Data
(60) Provisional application No. 63/571,926, filed on Mar. 29, 2024.

(51) Int. Cl. G10L 17/02; G10L 17/06

(52) U.S. Cl. CPC G10L 17/02; G10L 17/06

(57) ABSTRACT

In some embodiments, a method receives a first transcript that includes a first speaker and a second speaker. A boundary of a primary turn between the first speaker and the second speaker is determined in the first transcript. The method compares a time in which the first speaker paused to a threshold. When the threshold is met, speech by the second speaker is determined that should be labeled with a first label as the primary turn. When the threshold is not met, speech by the second speaker is determined that should be labeled with a second label as a secondary turn. The method transforms the first transcript into a second transcript based on whether speech is labeled with the first label or the second label. The second transcript is analyzed to generate an analysis of primary turns between the first speaker and the second speaker.

### CROSS REFERENCE TO RELATED APPLICATIONS

Pursuant to 35 U.S.C. § 119 (e), this application is entitled to and claims the benefit of the filing date of U.S. Provisional App. No. 63/571,926 filed Mar. 29, 2024, entitled “SEGMENT TRANSCRIPTS INTO NATURALISTIC CONVERSATIONAL TURNS”, the content of which is incorporated herein by reference in its entirety for all purposes.

### BACKGROUND

In a conversation, multiple people naturally speak. A speech to text application may transcribe the speech into text. To improve readability, the speech to text application may segment the transcript into speaking turns for respective speakers. For example, the transcript may be segmented into turns for speech from a speaker 1, speech for speaker 2, speech for speaker 1, etc. There may be some difficulty of determining accurate speaking turns when speakers speak in parallel. For example, speaker 2 may say something like “yeah, haha” while the other speaker is still talking. The speech to text application may insert a turn whenever someone speaks. Thus, the speech to text application creates a turn for speaker 2 with “yeah, haha”. This may interrupt the speech of speaker 1 in the transcript.

The accuracy of the speaking turns may affect the analysis of the transcript. For example, a data analytics or artificial intelligence application may analyze the data transcript. The accuracy, quality, or interpretability of the analysis may depend on an accurate segmentation of speaking turns in the transcript.

### BRIEF DESCRIPTION OF THE DRAWINGS

The included drawings are for illustrative purposes and serve only to provide examples of possible structures and operations for the disclosed inventive systems, apparatus, methods, and computer program products. These drawings in no way limit any changes in form and detail that may be made by one skilled in the art without departing from the spirit and scope of the disclosed implementations.

FIG. 1 depicts a simplified system for analyzing transcripts for natural turns according to some embodiments.

FIG. 2 depicts an example of a conversation and different turns according to some embodiments.

FIG. 3 depicts an example of a baseline transcript and a revised transcript with natural turns according to some embodiments.

FIG. 4 depicts another example of a revised transcript with natural turns according to some embodiments.

FIG. 5 depicts an example of a data structure that stores information for the revised transcript with natural turns according to some embodiments.

FIG. 6 depicts a simplified flowchart of a method for analyzing transcripts for primary turns and secondary turns according to some embodiments.

FIG. 7 depicts a simplified flowchart of a method for analyzing a revised transcript according to some embodiments.

FIG. 8 illustrates one example of a computing device according to some embodiments.

### DETAILED DESCRIPTION

Described herein are techniques for a speech analysis system. In the following description, for purposes of explanation, numerous examples and specific details are set forth to provide a thorough understanding of some embodiments. Some embodiments as defined by the claims may include some or all the features in these examples alone or in combination with other features described below, and may further include modifications and equivalents of the features and concepts described herein.

### System Overview

A system receives a transcript that was generated using a speech to text application. The system segments transcripts into primary turns and secondary turns. Primary turns are meant to approximate “naturalistic turns”—i.e., turns in a conversation that the participants themselves would recognize belong to the current speaker when it is “their turn” to speak. Thus, primary turns are distinct from “secondary” turns or utterances a listener makes during a speaker's primary turn. The system isolates primary speaking turns, which may be turns in a conversation that speakers themselves would recognize to belong to the speaker who is the primary speaker compared to secondary turns, which may be utterances a listener spoke during the primary turn of the primary speaker. The secondary turns may include different speech types, such as back channels (e.g., “mhmm”, “Yeah”), brief interjections stating a narrative (e.g., “Oh no”), or other forms of parallel speech that are hallmarks of dialog. The system may retain the timing and content of the secondary turns for analysis or display on an interface, but preserves them separately from the primary turn. The system may visually and functionally separate the secondary turns from the primary turns, which results in more naturalistic transcripts.

In some embodiments, in a two-person conversation (however, there could be more than two people), there is usually a primary speaker whose turn it is to speak and a listener (these roles are determined by tacit agreement). The system operates on the principle that once a speaker begins to talk, their “primary turn” continues until they are silent for some preset amount of time (e.g., a threshold); and a vocalization on the listener's part that appears during this primary turn is considered a secondary turn and removed from being identified as a primary turn. The system attempts to segment turns more accurately by disallowing turn exchanges until after the primary speaker has stopped talking for a period of time. In some embodiments, a 1.5 second threshold may be used to optimally determine primary turns.

The revised transcript may be analyzed by a transcript analysis system. The transcript analysis system may perform a more accurate analysis because the natural turns have been added to the revised transcript. For example, the analysis system may analyze a coaching conversation between a coach and a client. Having accurate natural turns may allow the analysis system to analyze responses by a coach to a client more accurately.

### System

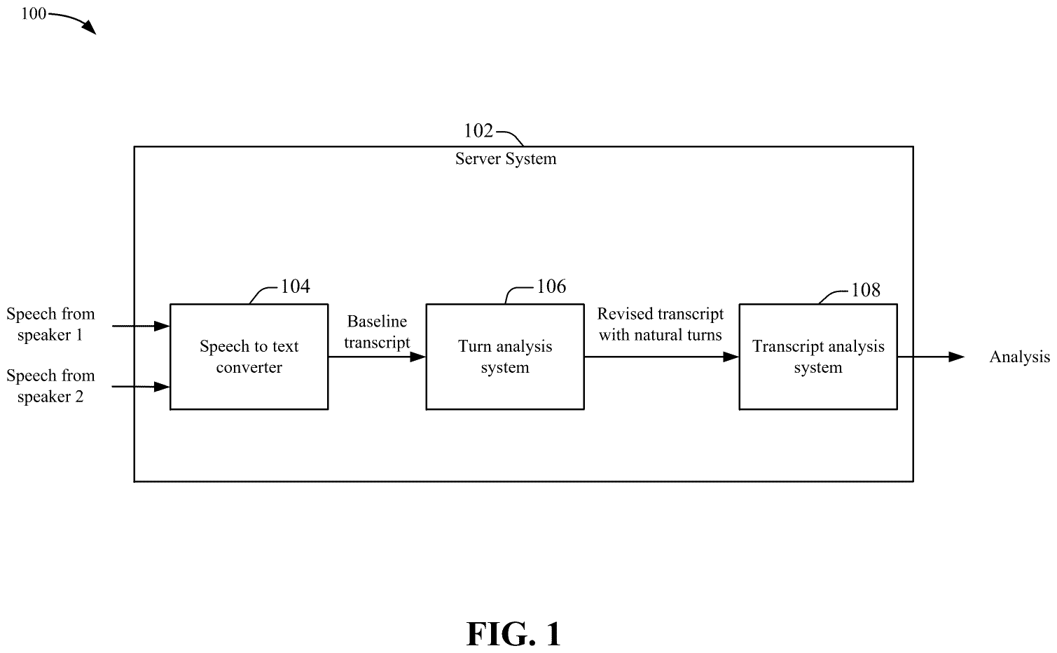

FIG. 1 depicts a simplified system 100 for analyzing transcripts for natural turns according to some embodiments. System 100 includes a server system 102, which may be implemented using one or more computing devices. Server system 102 may include a speech to text converter 104, a turn analysis system 106, and a transcript analysis system 108. The functions of components of server system 102 may be performed on a single computing device or distributed across multiple computing devices.

Speech to text converter 104 receives speech from multiple users. For discussion purposes, speech from a speaker 1 and a speaker 2 is used, but speech from any number of speakers may be received. Speech to text converter 104 converts the speech to text.

Speech to text converter 104 may generate a transcript file where each spoken word, such as a word token, is generated with start and stop time stamps. The word tokens are sorted chronologically and separated by stereo channel, such as a first speaker in the left channel and a second speaker in the right channel. Speech to text converter 104 may apply a baseline turn model to assign each word token to a respective speaker's turn. For example, a number of words may be assigned to speaker 1, and then when a turn is determined, speech to text converter 104 assigns a number of words to speaker 2 until another turn is determined. The baseline turn model may consider a turn whenever someone speaks. The resulting transcript may be referred to as a baseline transcript.

Turn analysis system 106 receives the baseline transcript, analyzes the baseline transcript, and outputs a revised transcript with natural turns. Turn analysis system 106 uses a natural turn model, which is different from the baseline turn model. The natural turn model isolates parallel speech, and retains its content and timing, but visually and functionally separates the parallel speech as secondary turns that are different from primary turns. In some embodiments, turn analysis system 106 assumes that once a speaker begins to talk, it is their primary turn to speak, and the other speaker is a listener. The primary turn continues as the primary speaker continues to speak until a condition is met. For example, turn analysis system 106 determines when the primary speaker pauses and is silent for an amount of time that meets a threshold. This may indicate a primary turn has occurred if speech from the other speaker occurs during the pause.

However, if the primary speaker does not pause for a time that meets the threshold, that speaker's subsequent speech, following a sub-threshold pause length, is still considered to be part of that primary turn, and any speech from the listener during the primary turn may be considered a secondary turn, and is labeled as such. Also, the speech labeled as a secondary turn may be removed from the primary turn in the revised transcript, and placed into a separate field in the transcript record that indicates its temporal, parallel relationship to its associated primary turn. Turn analysis system 106 attempts to segment turns more accurately by disallowing turn exchanges until after the primary speaker has stopped talking for a period of time. This provides more naturalistic turns in the revised transcript.

Turn analysis system 106 includes a parameter that affects turn segmentation, which may be referred to as a “max_pause” setting. This parameter dictates the maximum duration of silence from a current primary turn speaker after which resumed speech is still considered part of the same primary turn. Turn analysis system 106 calibrates this parameter to generate transcripts that improve baseline transcripts. The max pause value may effectively avoid both false positives (e.g., merging two utterances from the same speaker in different turns—indicating that max_pause is set too high) and false negatives (e.g., separating two utterances from the speaker in the same turn—suggesting max_pause is too low). Also, turn analysis system 106 may include an adaptive max pause parameter sensitive to both individual and dyadic speech cadences. For example, the max pause parameter may be adjusted based on different speaking styles for different speakers, such as a speaker who speaks slower with longer pauses may have a longer max pause value compared to a speaker that speaks faster with shorter pauses.

Other parameters may also be used. For example, backchannel identification parameters may be used to determine when listener speech is a backchannel. For example, if a listener says “yeah”, this is probably a backchannel if the primary speaker is still speaking. but if the listener says “yeah I loved that movie!” then it is not necessarily that the listener wants the speaker to stop talking so the listener can say more, but it is more than what would qualify as a backchannel. The parameters attempt to understand the different variations in listener speech and what they mean/signal. The parameters may include a maximum number of words in an utterance to be considered a backchannel, a maximum length of an utterance (in seconds) to be considered a backchannel, a maximum length of a pause needed to consider the next turn a backchannel, a proportion of words that are backchannel cues for a short utterance to be considered a backchannel, tokens that are considered to be backchannels, optional tokens that can be used to indicate the start of a short turn rather than a backchannel and other parameters, and other parameters.

The revised transcript with natural turns may generate longer contiguous primary turns and isolate listener utterances that occur during the speakers primary turn into secondary turns. Turn analysis system 106 may also label the secondary speech with type labels, such as back channel, assessments, reactive, etc. The type labels of the secondary speech may be used downstream by transcript analysis system 108.

Transcript analysis system 108 receives the revised transcript with natural turns, analyzes the revised transcript, and outputs an analysis. The analysis may be different types of analysis. For example, the analysis may analyze the conversation to provide constructive feedback for improvement to one of the speakers. In some embodiments, the responses by the coach may be analyzed to provide suggestions for improvement in coaching. The analysis may be improved by having accurate turns in the conversation. For example, by not having an accurate turn in the conversation, transcript analysis system 108 may not be able to correctly analyze the response by a coach. If a primary turn for the coach is considered the speech of “yes mhmm”, the analysis may be that the coach did not provide a comprehensive response to the client. However, this speech may just be a backchannel to acknowledge the client while allowing the client to continue to speak. Having a turn in the transcript for this backchannel speech fails to convey the conversation accurately to the analysis system.

The following will now describe the system in more detail. Examples of conversations will be described first.

### Natural Turns

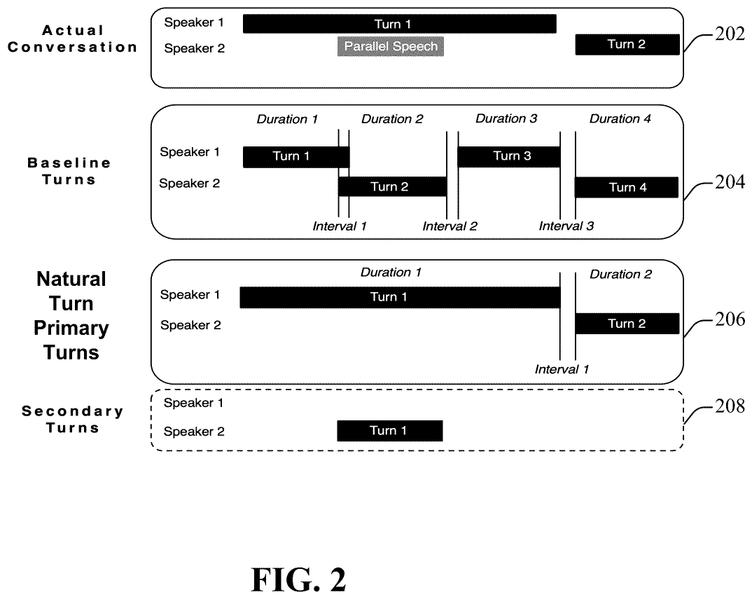

FIG. 2 depicts an example of a conversation and different turns according to some embodiments. At 202, an actual conversation is shown. A speaker 1 and a speaker 2 are speaking. Speaker 1 speaks in a turn 1 and speaker 2 speaks with an overlap of turn 1. For example, at first, speaker 1 may be speaking while speaker 2 is listening. Then, while speaker 1 is speaking, speaker 2 may utter other some words in parallel, which are labeled as “overlap”. Then, speaker 2 speaks in a turn 2 after an interval of silence.

FIG. 2 depicts a comparison between traditional baseline turn segmentation and the Natural Turn approach. At 202, an actual conversation is shown between Speaker 1 and Speaker 2. In this example, Speaker 1 begins speaking in Turn 1, and while still speaking, Speaker 2 produces a brief overlap utterance, labeled “parallel speech.” After Speaker 1 finishes and a silence interval occurs, Speaker 2 then speaks in Turn 2.

A key innovation of natural turns is how the system handles this overlap differently from baseline methods. While baseline segmentation would split the conversation into multiple short, fragmented turns (creating artificial breaks in Speaker 1's speech), natural turns preserve Speaker 1's continuous speech as a single “primary turn” while categorizing Speaker 2's brief interjection as a “secondary turn” or utterance. This approach better reflects the natural psychological perception of turn-taking by conversation participants.

At 204, the baseline turns are shown. Speaker 1 includes a turn 1 with a duration 1. Then, speaker 2 includes a turn 2 with a duration 2. An interval 1 and an interval 2 include overlap with speaker 1. For example, interval 1 overlaps turn 1 and turn 2. Interval 2 overlaps turn 2 for speaker 2 and turn 3 for speaker 1.

After turn 2, speaker 1 speaks for a duration 3 in a turn 3. There is an interval 3 where neither speaker 1 nor speaker 2 speaks. Then, speaker 2 speaks for a turn 4 with a duration 4. As can be seen, the overlap of speaker 2 with turn 1 in the actual conversation results in a turn 2 between speaker 1 and speaker 2 in the baseline turns. This splits turn 1 in the actual conversation into turn 1 and turn 3 for speaker 1. However, speaker 1 may have been primarily speaking during this time and speaker 2 may have only uttered a small amount of words.

At 206, the primary turns of the transcript are shown with natural turns. A primary turn is where speech switches from one speaker to another. Speaker 1 includes a turn 1 of a duration 1. Then, an interval 1 occurs, and a turn 2 for speaker 2 of a duration 2 occurs. There is no overlap of turn 2 from the baseline turns in the primary turn 1. Thus, turn 1 and turn 3 of the baseline turns are combined into a turn 1 in the primary turns. Compared to the baseline turns, there are only two primary turns compared to four primary turns in the baseline turns.

A 208, the secondary turns are shown. A secondary turn is where speech does not switch from one speaker to another in the primary turn. Speaker 1 does not include any secondary turns. However, speaker 2 includes a secondary turn 1 that corresponds to the turn 2 in the baseline turns. Thus, the primary turns are separated by the natural turns, and the secondary turns are separated from the primary turns.

The primary turns are more naturalistic with the separation of secondary turn 2. Turn analysis system 106 has a major influence on the sequencing and measurement of conversational turns. Specifically, when a conversation contains parallel speech—depicted here as a brief period of “overlap” by speaker 2 while speaker 1 is talking—the natural turn transcript and baseline turn transcript diverge considerably in the way that they represent the turns' durations and intervals. Compare the baseline transcript's series of short overlapping turns (Baseline Turns 1-3) to the natural turn transcript single long turn (Natural turn Turn 1). Further, what is recorded as three intervals between the baseline transcript turns, including both gaps and overlaps, becomes just one interval between the natural turn transcript, a single gap.

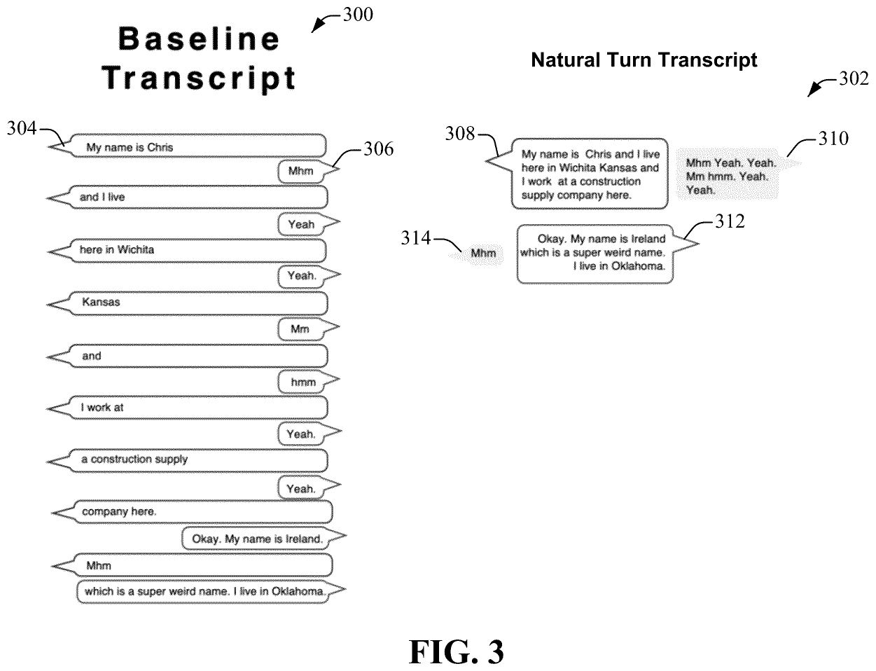

FIG. 3 depicts an example of a baseline transcript and a revised transcript with natural turns according to some embodiments. A baseline transcript is shown at 300 and a revised transcript with natural turns is shown at 302. The baseline transcript depicts the initial stages of a conversation in which two individuals are introducing themselves. During the first speaker's introduction, his conversation partner eagerly contributes backchannels such as “yeah” and “mhm” to demonstrate that she is engaged; these short affiliative utterances are examples of “secondary speech” or “parallel speech”. However, the baseline transcript records each of these listener backchannels as their own distinct primary speaking turns. Turn analysis system 106 treats this speech differently and removes it from the primary turn registry. Turn analysis system 106 determines which secondary turns are assigned a “Backchannel” type label, such as by using a predefined cue list of common backchannel words (e.g., “yeah,” “exactly”, etc.). Turn analysis system 106 may also use rules to determine when to assign speech to the secondary turn. In some embodiments, the rules are: (1) A backchannel turn may be three words or fewer; (2) A backchannel turn may not begin with a prohibited word (e.g., “I'm . . . ”), and (3) More than half of the words in the turn may be backchannel words.

In the baseline transcript, a speaker 1 primary turn is shown with bubbles pointing towards 304 and a speaker 2 primary turn is shown with bubbles pointing towards 306. The baseline transcript treats each interjection of speech as a turn, which disrupts the flow of conversation. For example, speaker 1 is trying to introduce himself by saying “My name is Chris and I live in here in Wichita Kansas and I work at a construction supply company here.”, but this is broken up by speaker 2. In total, speaker 2 breaks up the conversation of speaker 1 seven times resulting in seven turns.

At 302, the revised transcript with natural turns segments the same information into a more naturalistic format by isolating listener secondary turns, such as back channels, leaving only primary speakers alternating with respective introductions. For example, at 308, the speaker 1 primary turn is shown with the full sentence introducing himself. At 310, the utterances of speaker 2 are turned into a secondary turn and removed from the primary turns. Then, at 312, the primary turn of speaker 2 is shown where speaker 2 introduces herself. The removal of the secondary turn to a different column makes the primary conversation more natural and readable while still visually noting the second turns. At 314, a secondary turn of speaker 1 for the speech of “Mhm” also is removed.

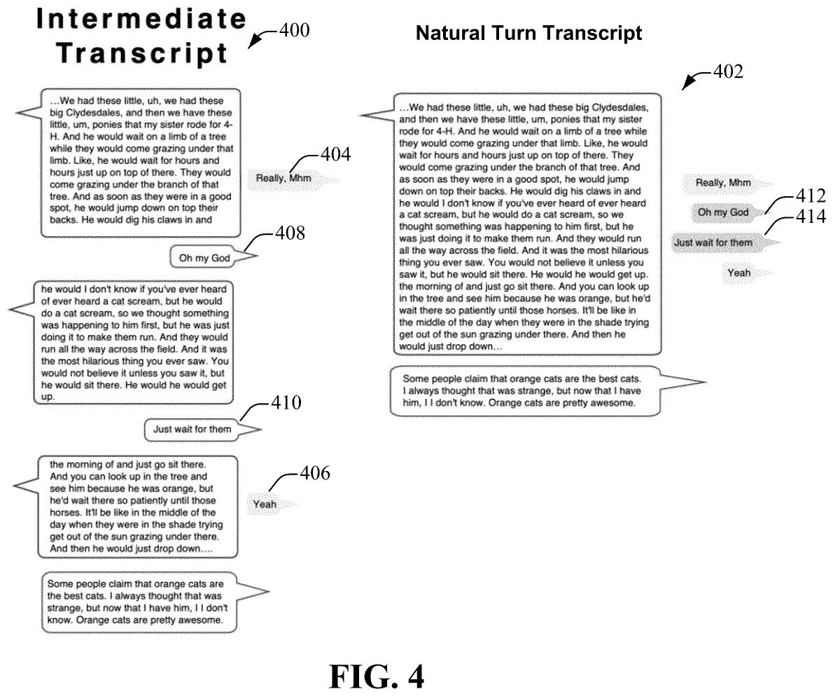

FIG. 4 depicts another example of a revised transcript with natural turns according to some embodiments. The following is used to show additional revisions that turn analysis system 106 may use. For discussion purposes, an intermediate transcript is shown at 400 and a revised transcript with natural turns is shown at 402.

The intermediate transcript depicts another point in the conversation in which a participant is sharing a story. The intermediate transcript indicates that even with backchannels removed, speakers' primary turns are often still interrupted by other forms of parallel speech, such as language that mirrors a storyteller's emotion or reinforces key moments in a narrative (e.g., “Oh my God,” and “Just wait for them”). Unlike backchannels, these additional types of parallel speech are difficult to identify using a fixed cue list, and turn analysis system 106 segregates primary turn speech and secondary turn speech based upon the timing of utterances rather than their content (e.g., primary turns continue until a speaker has stopped talking for some fixed threshold—here parameterized as 1.5 seconds). In this way, parallel listener utterances are identified and isolated from the primary turn flow.

In the intermediate transcript, back channels have been removed at 404 from the primary conversation. However, parallel speech still remains at 408 and 410. Here, speaker 2 is interjecting in the conversation of speaker 1. For example, speaker 2 breaks up the conversation by saying “Oh my God” and “Just wait for them”. These routine interjections may still unnaturally break up the conversation of speaker 1. At 402, the revised transcript removes the parallel speech. For example, at 412 and, 414, the phrases “Oh my God” and “Just wait for them” have been removed from the primary turn and moved to the secondary turn.

In both FIG. 3 and FIG. 4, an interface displaying the transcript is improved. For example, the primary turns that are displayed are visually improved as primary turns are not broken up by parallel speech. The interface is also improved by displaying the secondary turns positionally in a second channel where the speech occurred in parallel with the primary turn, but not breaking up the primary turns in a first channel. For example, the secondary turns are positioned in a second channel that is next to a first channel of the primary turn in which the parallel speech occurred in a time order in which the parallel speech occurred.

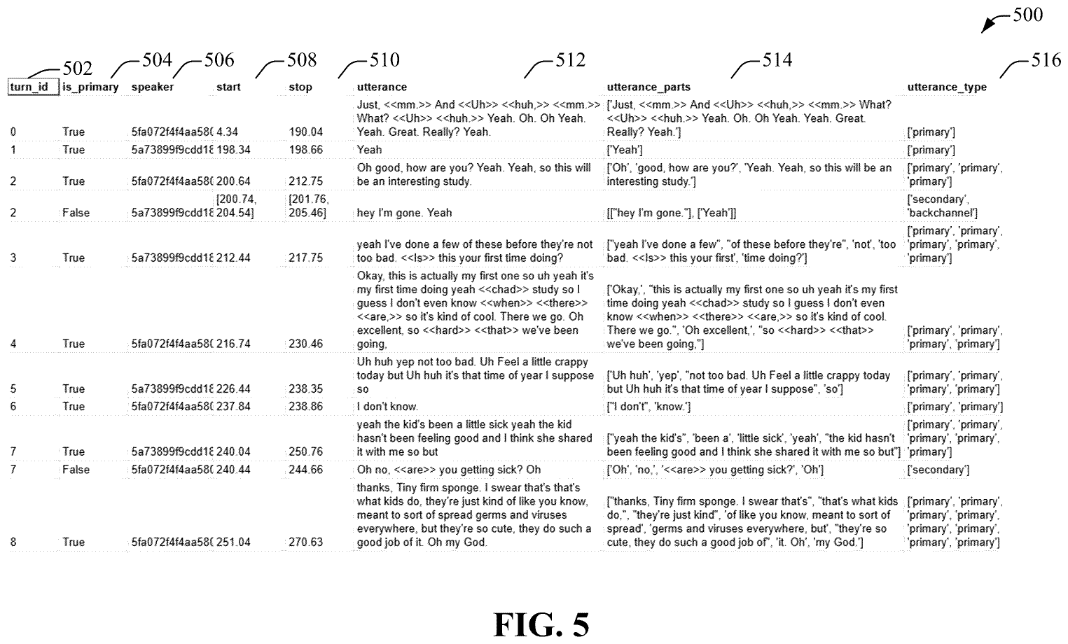

FIG. 5 depicts an example of a data structure 500 that stores information for the revised transcript with natural turns according to some embodiments. A column 502 stores the turn identifier. The turn identifier may be from the turns of the baseline transcript.

A column 504 whether the turn identifier is associated with a primary turn or not. The value of “true” indicates this is a primary turn, and the value of “false” indicates this is a secondary turn, which was transformed from a primary turn in the baseline transcript.

A column 506 identifies the speaker. There are two speaker identifiers in this example.

A column 508 and a column 510 identify the start time and the stop time of the speech. The start time is when the speech starts in the transcript and the stop time is when the speech stops in the transcript.

A column 512 identifies the speech and a column 514 identifies parts of the speech. The parts of the speech may break the speech in column 512 into parts. For example, “oh good, how are you?” may be broken into “oh” “good, how are you?”. The parts may include start and stop times, which may be used to determine timing information for parts of the speech.

A column 516 identifies labels for the speech. The labels may be the type of speech. The label “primary” is for speech that is in a primary turn. The labels for speech in a secondary turn may be the type of secondary speech. For example, labels include back channel, secondary speech, and other types. Back channel speech may be brief listener responses that signal attention, understanding, or agreement without taking the speaker turn without taking the speaker during turn. They include non-lexical utterances like “mm-hmm,” “uh-huh,” and “hmm.” Backchannels help maintain the speaker's flow and indicate that the listener is engaged. Reactive tokens, also known as response tokens, are short utterances or gestures that display a listener's immediate reaction to the speaker's talk. They can express surprise (“Oh!”), empathy (“Oh dear”), or other emotions, providing feedback on the speaker's message. Continuers are specific types of backchannels that encourage the speaker to continue their narrative. Utterances like “go on” or “and then?” signal that the listener is following along and interested in hearing more. Aizuchi is a Japanese term referring to frequent interjections during a conversation, such as “hai” (“yes”) or “un” (“yeah”). Aizuchi serves to show active listening and encourage the speaker to continue, reflecting cultural norms of engagement in Japanese discourse. Assessments are evaluative comments or sounds that convey the listener's judgment or opinion about the speaker's statement. For example, saying “That's interesting” or “Wow” provides an evaluative response, contributing to the shared understanding of the topic. Collaborative completions occur when a listener finishes the speaker's sentence, demonstrating a high level of engagement and shared understanding. It can affirm the speaker's thoughts and strengthen the conversational bond. Clarification requests are when a listener seeks to resolve ambiguity or gain a better understanding, they may use phrases like “Do you mean . . . ?” or “Could you explain that?” These requests ensure mutual comprehension and facilitate effective communication.

Accordingly, in some cases, turns that occur in the baseline transcript may be labeled as false when turn analysis system 106 determines that the speech is classified as a secondary turn. These primary turns are turned into secondary turns transforming the data stored for the transcript to label the speech as a secondary turn. Also, the type of speech that is in the secondary turn may be analyzed and labeled with different labels. These labels may be used in the analysis of the transcript. The label may be determined differently.

### Turn Analysis

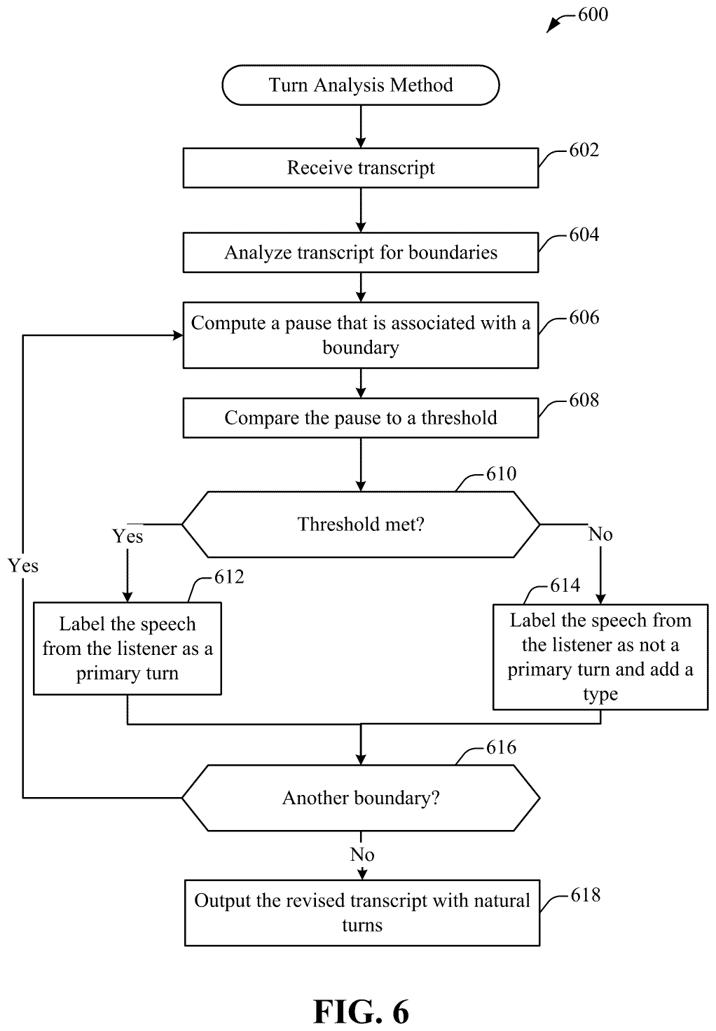

FIG. 6 depicts a simplified flowchart 600 of a method for analyzing transcripts for primary turns and secondary turns according to some embodiments. At 602, turn analysis system 106 receives a transcript. The transcript may be the baseline transcript.

At 604, turn analysis system 106 analyzes the transcript for boundaries. The boundaries may be the turns that have been determined in the baseline transcript. The turns are from a first speaker 1 to a second speaker 2, or vice versa. For example, a boundary may be at 190.04 from turn 0 where speaker 1 stops speaking.

At 606, turn analysis system 106 computes a pause that is associated with the boundary. A pause may be a time in which the primary speaker stops speaking. The pause may be measured by the stop time of the last word to the start time of the next word of the speaker. For example, the pause may be 198.66−190.04=8.62 seconds between turn 0 and turn 1.

At 608, turn analysis system 106 compares the pause to a threshold. In some embodiments, the threshold may be a predetermined time, such as 1.5 seconds. Other times may be appreciated though. The time of 1.5 seconds may provide naturalistic turns in the revised transcript by limiting some parallel speech that occurs while not allowing long pauses.

At 610, turn analysis system 106 determines if the threshold is met. By the threshold being met, the pause may be greater than the threshold. If the threshold is met, at 612, the speech from the listener is labeled as a primary turn. In this case, a primary turn occurs, and the listener becomes the primary speaker. For example, turn 0 and turn 1 are primary turns because the pause of 8.62 seconds is greater than 1.5 seconds.

If the threshold is not met, at 614, turn analysis system 106 labels the speech from the listener as not a primary turn and add a type label to the secondary speech. By the threshold not being met, the pause may be less than the threshold. The label may be selected from any of the labels described above. This transforms the baseline transcript by adjusting a primary turn to a secondary turn. For example, in turn 2, speaker 1 stops talking at 212.75. Speaker 2 talks in the times 201.76-205.46.)

At 616, turn analysis system determines if another boundary is encountered. If another boundary is encountered, the process reiterates to 606 to compute another pause. For example, another boundary may be encountered at turn 1.

If another boundary is not encountered, at 618, turn analysis system 106 outputs the revised transcript with natural turns. The revised transcript may have two primary turns that are false, turn 2 and turn 7. These primary turns are turned into secondary turns and labeled with types of secondary speech.

The revised transcript may also be displayed on an interface. For example, the data from data structure 500 is used to display the primary turns and the secondary turns as shown in FIG. 3 and FIG. 4. When server system 102 encounters a false flag in column 504, server system 102 moves the speech to a secondary turn. The speech labels with a true flag in column 504 is displayed as a primary turn. The interface is improved because the primary turns and the secondary turns being separated improves the readability of the transcript.

The revised transcript may also be analyzed.

### Transcript Analysis

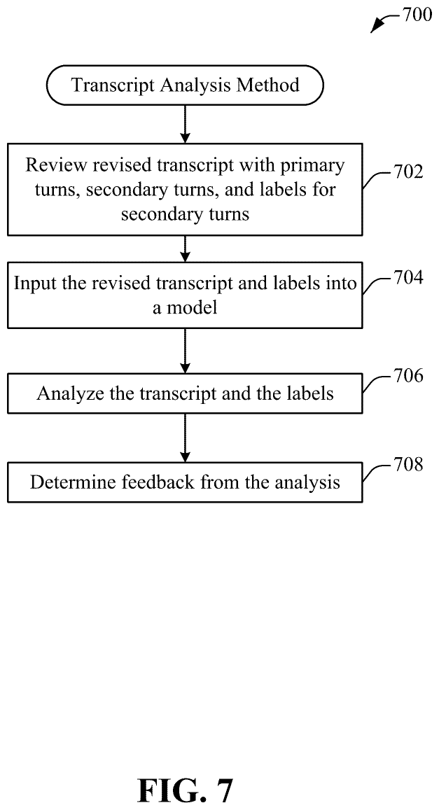

FIG. 7 depicts a simplified flowchart 700 of a method for analyzing a revised transcript according to some embodiments. At 702, transcript analysis system 108 receives the revised transcript with primary turns, secondary turns, and labels for secondary turns. For example, transcript analysis system 108 may review the data structure in FIG. 5.

At 704, transcript analysis system 108 may input the transcript and the labels into a model. For example, the model may be a large language model that is configured to analyze text. A prompt may be input into a large language model to provide direction on how to analyze the transcript. For example, the prompt may ask the large language model to critique the coaches coaching of the client.

At 706, the model analyzes the transcript and the labels. For example, the labels may be used in the analysis

At 708, transcript analysis system 108 determines feedback from the analysis. The feedback may include pointers to the coach on how to improve the coaching.

### CONCLUSION

Accordingly, the revised transcript with natural turns may provide a more naturalistic conversation between speakers. This allows analysis of the revised transcript to be improved. Also, an interface showing the primary turns and the secondary turns may be improved by showing the primary turns and secondary turns more clearly. For example, the primary conversation may be more naturalistic and readable. Also, the secondary turns may also be reviewed, but not take away from the primary conversation.

### System

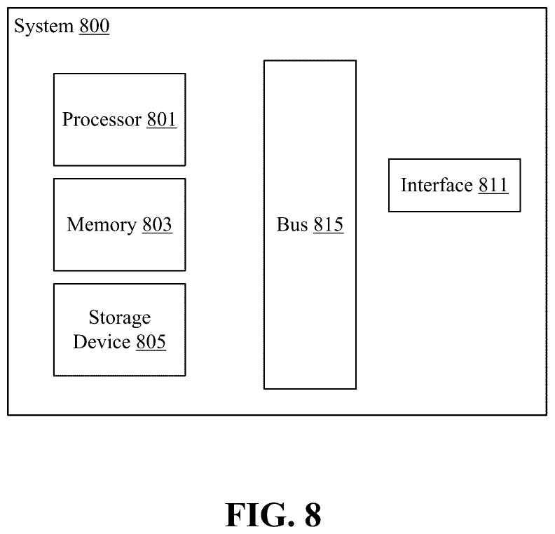

FIG. 8 illustrates one example of a computing device according to some embodiments. According to various embodiments, a system 800 suitable for implementing embodiments described herein includes a processor 801, a memory 803, a storage device 805, an interface 811, and a bus 815 (e.g., a PCI bus or other interconnection fabric.) System 800 may operate as a variety of devices such as server system 102, or any other device or service described herein. Although a particular configuration is described, a variety of alternative configurations are possible. Processor 801 may perform operations such as those described herein. Instructions for performing such operations may be embodied in memory 803, on one or more non-transitory computer readable media, or on some other storage device. Various specially configured devices can also be used in place of or in addition to processor 801. Memory 803 may be random access memory (RAM) or other dynamic storage devices. Storage device 805 may include a non-transitory computer-readable storage medium holding information, instructions, or some combination thereof, for example instructions that when executed by the processor 801, cause processor 801 to be configured or operable to perform one or more operations of a method as described herein. Bus 815 or other communication components may support communication of information within system 800. The interface 811 may be connected to bus 815 and be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

Any of the disclosed implementations may be embodied in various types of hardware, software, firmware, computer readable media, and combinations thereof. For example, some techniques disclosed herein may be implemented, at least in part, by non-transitory computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Java, Python, C++, C, HTML, any other markup language, JavaScript, ActiveX, VBScript, or Perl. Examples of non-transitory computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A non-transitory computer-readable medium may be any combination of such storage devices.

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

Some embodiments may be implemented in a non-transitory computer-readable storage medium for use by or in connection with the instruction execution system, apparatus, system, or machine. The computer-readable storage medium contains instructions for controlling a computer system to perform a method described by some embodiments. The computer system may include one or more computing devices. The instructions, when executed by one or more computer processors, may be configured or operable to perform that which is described in some embodiments.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of some embodiments may be implemented. The above examples and embodiments should not be deemed to be the only embodiments and are presented to illustrate the flexibility and advantages of some embodiments as defined by the following claims. Based on the above disclosure and the following claims, other arrangements, embodiments, implementations, and equivalents may be employed without departing from the scope hereof as defined by the claims

What is claimed is:

1. A method comprising:
receiving a first transcript that includes a first speaker and a second speaker;
determining a boundary of a primary turn between the first speaker and the second speaker in the first transcript;
comparing a time in which the first speaker paused to a threshold;
when the threshold is met, determining speech by the second speaker should be labeled with a first label as the primary turn;
when the threshold is not met, determining speech by the second speaker should be labeled with a second label as a secondary turn;
transforming the first transcript into a second transcript based on whether speech is labeled with the first label or the second label; and
analyzing the second transcript to generate an analysis of primary turns between the first speaker and the second speaker.

2. The method of claim 1, wherein the first transcript that is received includes primary turns that are based on determining when the first speaker and the second speaker speak.

3. The method of claim 1, wherein the boundary is determined when a switch occurs from the first speaker speaking to the second speaker speaking or from the second speaker speaking to the first speaker speaking.

4. The method of claim 1, wherein comparing the time in which the first speaker paused comprises:
determining a stop time in which the first speaker stopped speaking; and
determining a start time in which the first speaker started speaking after the first speaker stopped speaking.

5. The method of claim 4, wherein the time is based on the stop time and the start time.

6. The method of claim 1, wherein the primary turn is when the first transcript switches from the first speaker to the second speaker, or vice versa.

7. The method of claim 1, wherein the secondary turn is where speech from the second speaker or the first speaker does not cause a switch from the first speaker to the second speaker, or vice versa, and is in parallel with the first speaker or the second speaker.

8. The method of claim 1, further comprising:
displaying the second transcript with primary turns and secondary turns.

9. The method of claim 1, wherein:
speech associated with the primary turns is displayed in a first channel, and
speech associated with the secondary turns is displayed in a second channel.

10. The method of claim 9, wherein speech in the first channel and speech in the second channel are visually separated.

11. The method of claim 1, wherein when the threshold is not met, determining the speech by the second speaker should be labeled with a second label as the secondary turn comprises:
adjusting the speech from being labeled as the primary turn to being labeled as the secondary turn.

12. The method of claim 1, wherein the threshold comprises 1.5 seconds.

13. The method of claim 1, further comprising:
when the threshold is not met, labeling a word in the speech by the second speaker with a type of secondary speech.

14. The method of claim 1, wherein analyzing the second transcript comprises:
determining an analysis of the second transcript based on the primary turns and secondary turns.

15. The method of claim 14, wherein analyzing the second transcript comprises:
analyzing a type label for a word labeled as the secondary turn to determine the analysis.

16. The method of claim 15, wherein:
the type label is determined from a plurality of types, and
the type label is determined based on a word in the speech.

17. A non-transitory computer-readable storage medium having stored thereon computer executable instructions, which when executed by a computing device, cause the computing device to be operable for:
receiving a first transcript that includes a first speaker and a second speaker;
determining a boundary of a primary turn between the first speaker and the second speaker in the first transcript;
comparing a time in which the first speaker paused to a threshold;
when the threshold is met, determining speech by the second speaker should be labeled with a first label as the primary turn;
when the threshold is not met, determining speech by the second speaker should be labeled with a second label as a secondary turn;
transforming the first transcript into a second transcript based on whether speech is labeled with the first label or the second label; and
analyzing the second transcript to generate an analysis of primary turns between the first speaker and the second speaker.

18. The non-transitory computer-readable storage medium of claim 17, wherein the first transcript that is received includes primary turns that are based on determining when the first speaker and the second speaker speak.

19. The non-transitory computer-readable storage medium of claim 17, further operable for:
displaying the second transcript with primary turns and secondary turns.

20. An apparatus comprising:
one or more computer processors; and
a computer-readable storage medium comprising instructions for controlling the one or more computer processors to be operable for:
receiving a first transcript that includes a first speaker and a second speaker;
determining a boundary of a primary turn between the first speaker and the second speaker in the first transcript;
comparing a time in which the first speaker paused to a threshold;
when the threshold is met, determining speech by the second speaker should be labeled with a first label as the primary turn;
when the threshold is not met, determining speech by the second speaker should be labeled with a second label as a secondary turn;
transforming the first transcript into a second transcript based on whether speech is labeled with the first label or the second label; and
analyzing the second transcript to generate an analysis of primary turns between the first speaker and the second speaker.
